(19) United States
(12) Patent Application Publication
(10) Pub. No.: US 2026/0253129 A1
(43) Pub. Date: Aug. 27, 2026

(54) RELATIONSHIP CLASSIFIER AND QUERY SCOPE CONTROL

(71) Applicant: Adobe Inc., San Jose, CA (US)

(72) Inventors: Victor Soares Bursztyn, Redwood City, CA (US); Xiang Chen, San Jose, CA (US); Sai Sree Harsha, San Jose, CA (US); Eunyee Koh, San Jose, CA (US); Akash Vivek Maharaj, Palo Alto, CA (US)

(73) Assignee: Adobe Inc., San Jose, CA (US)

(21) Appl. No.: 19/062,182

(22) Filed: Feb. 25, 2025

(51) Int. Cl. G06Q 30/0601; G06F 16/3329

(52) U.S. Cl. CPC G06Q 30/0641; G06F 16/33295

(57) ABSTRACT

Relationship classifier and query scope control techniques are described as implemented by a question answering system. By employing a classifier machine-learning model trained on both user-generated and machine-generated queries, the question answering system is configured to accurately determine whether a product query is within the scope of processing capabilities of corresponding product machine-learning models. The question answering system also supports an ability to generate machine-generated queries with increasing levels of abstraction that further supports comprehensive training data. Additionally, a sampling technique may be used by the question answering system as part of training data generation in order to promote a balanced training dataset.

### BACKGROUND

Query answering systems have been developed to employ machine learning to generate answers to questions that are applicable to a variety of usage scenarios. In some scenarios, however, these techniques are challenged with striking a balance between generalized usage and applicability to particular usage scenarios.

A machine-learning model trained using generalized training data, for instance, while functioning well for generalized knowledge will struggle with accuracy in specialized scenarios. On the other hand, a machine-learning model trained using specialized training data may not function for use in scenarios outside of that specialization. Accordingly, processing queries in scenarios that are not supported by the machine-learning models may lead to inaccuracies, inefficient use of computational resources, and affect power consumption of devices that supports these models.

### SUMMARY

Relationship classifier and query scope control techniques are described as implemented by a question answering system. By employing a classifier machine-learning model trained on both user-generated and machine-generated queries, the question answering system is configured to accurately determine whether a product query is within the scope of processing capabilities of corresponding product machine-learning models. This approach improves accuracy in query processing while also enhancing computational efficiency and power conservation by avoiding unnecessary processing of out-of-scope queries.

The question answering system also supports an ability to generate machine-generated queries with increasing levels of abstraction that further supports comprehensive training data, addressing challenges related to data sparsity and bias when limited to sole use of user-generated queries. Additionally, a sampling technique may be used by the question answering system as part of training data generation in order to promote a balanced training dataset, further improving performance of the classifier machine-learning model. As a result, the relationship classifier and query scope control techniques enable a question answering system to strike a balance between generalized usage and applicability to specific scenarios, resulting in increased accuracy and efficient query processing across a variety of usage scenarios.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

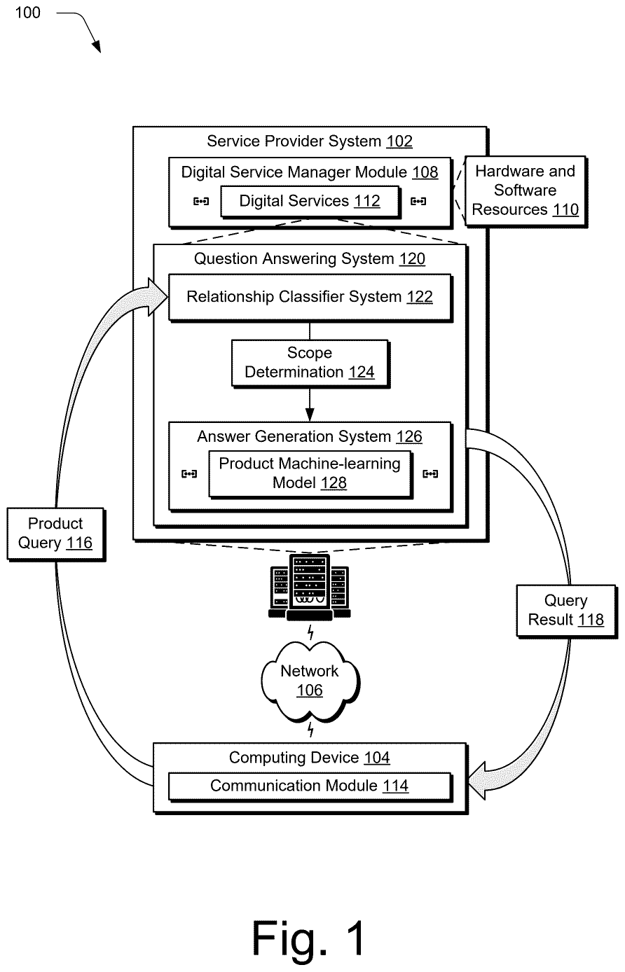

FIG. 1 is an illustration of a digital medium environment in an example implementation that is operable to employ relationship classifier and query scope control techniques through use of a classifier machine-learning model as described herein.

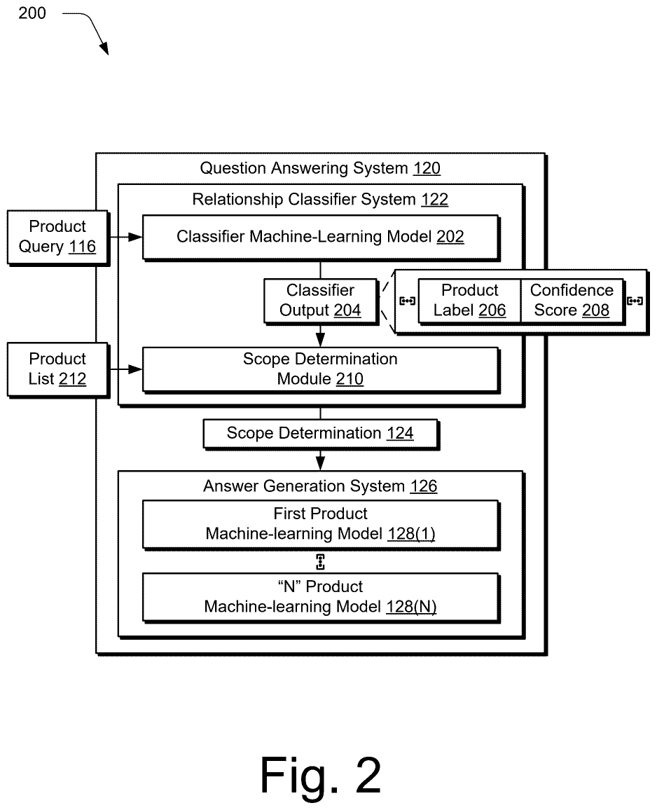

FIG. 2 depicts a system in an example implementation showing operation of a relationship classifier system of a question answering system of FIG. 1 in greater detail.

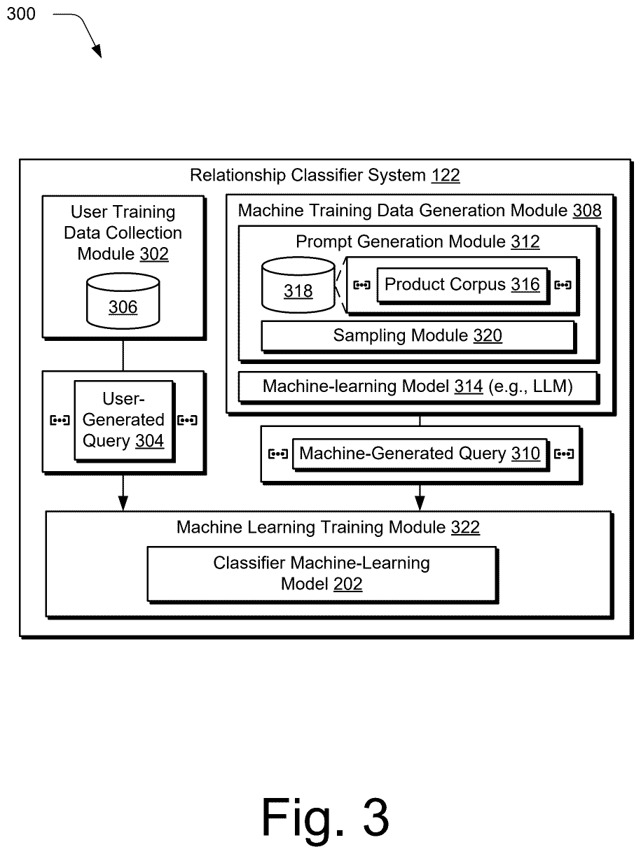

FIG. 3 depicts a system in an example implementation showing operation of a relationship classifier system of FIG. 1 in greater detail as collecting user-generated queries and machine-generated queries in order to train a classifier machine-learning model of FIG. 2.

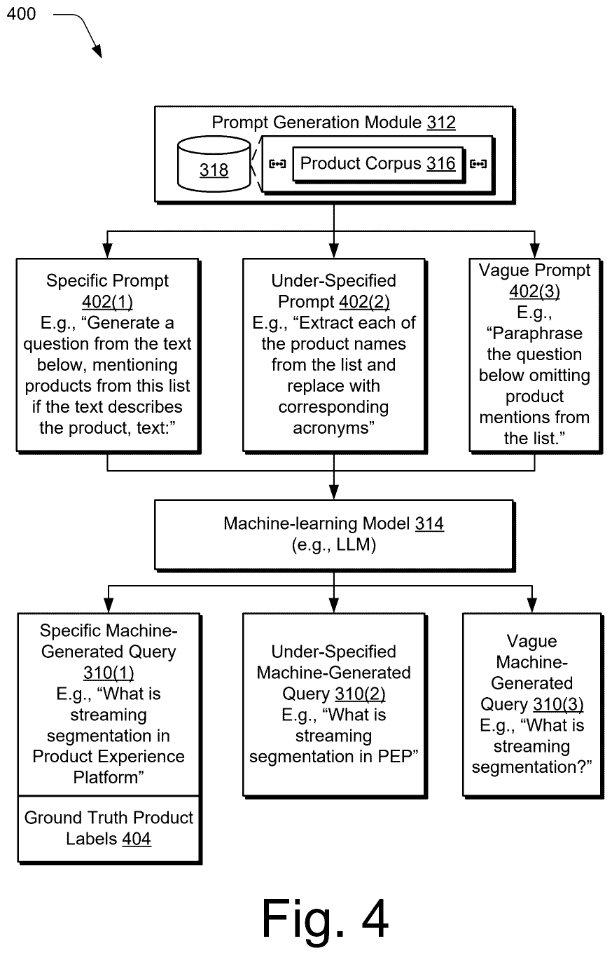

FIG. 4 depicts a system in an example implementation of incremental prompt generation over successive iterations as promoting increasing levels of abstraction in machine-generated queries by a prompt generation module of FIG. 3.

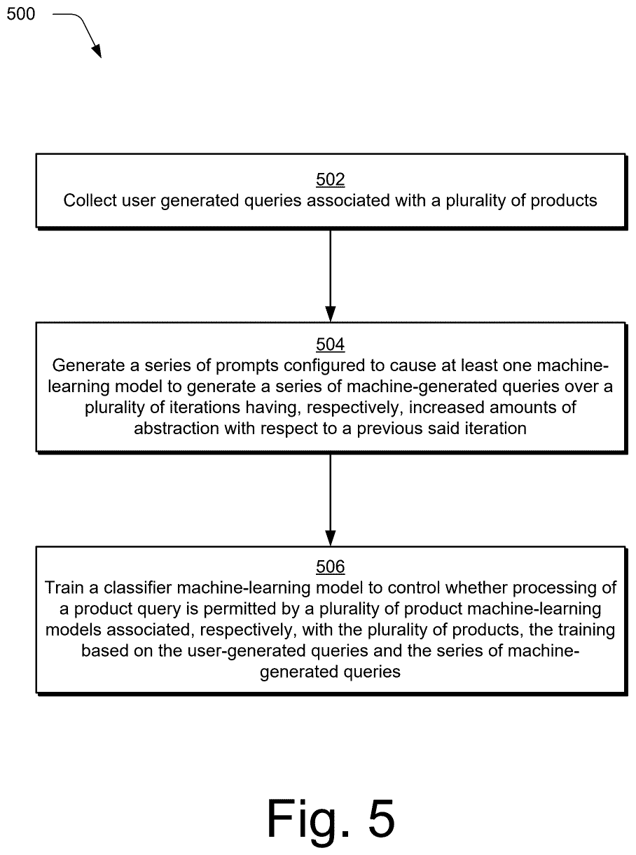

FIG. 5 is a flow diagram depicting an algorithm as a step-by-step procedure in an example implementation of operations performable for accomplishing a result of generating a series of prompts over a series of iterations having, successively, increased levels of abstraction with respect to a previous iteration.

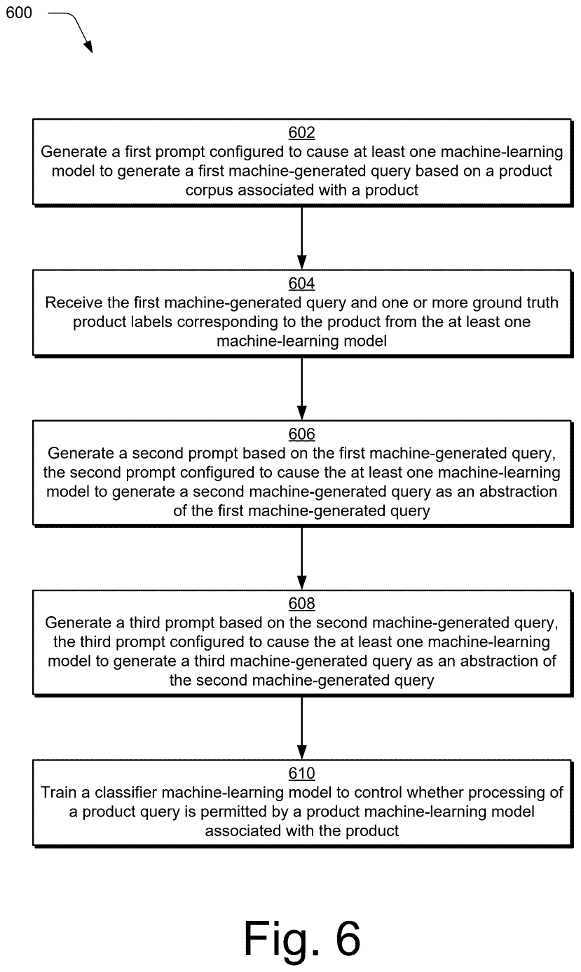

FIG. 6 is a flow diagram depicting an algorithm as a step-by-step procedure in an example implementation of operations performable for accomplishing a result of generating a series of three prompts which causes the machine-learning model to generate a corresponding series of three machine-generated queries.

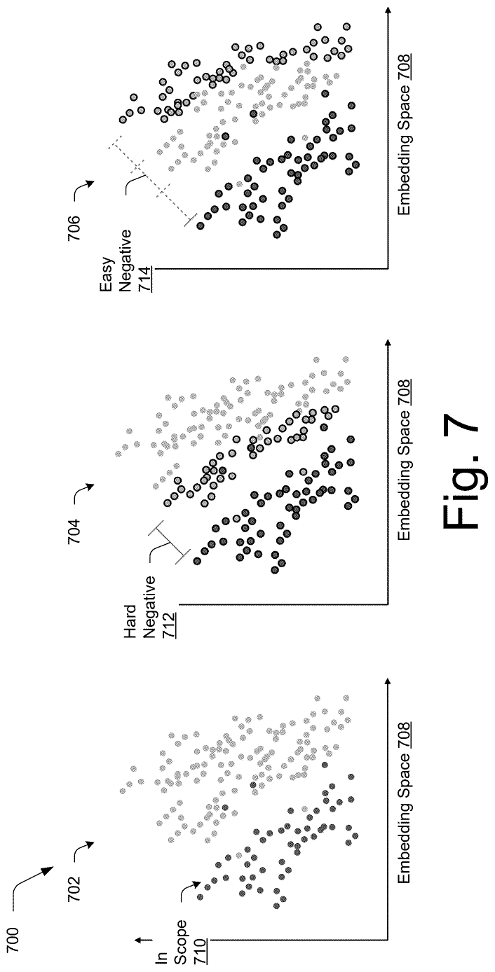

FIG. 7 depicts an example implementation of sample selection for inclusion in training data to train a classifier machine-learning model of FIG. 2.

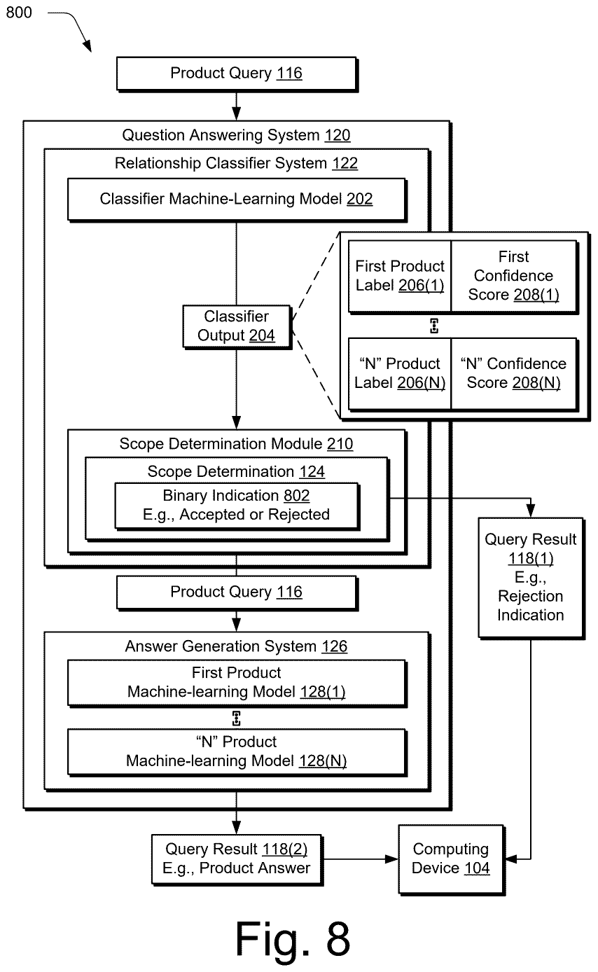

FIG. 8 depicts a system in an example implementation of use of a classifier machine-learning model as trained using the training data of FIGS. 5-7 to implement query scope control.

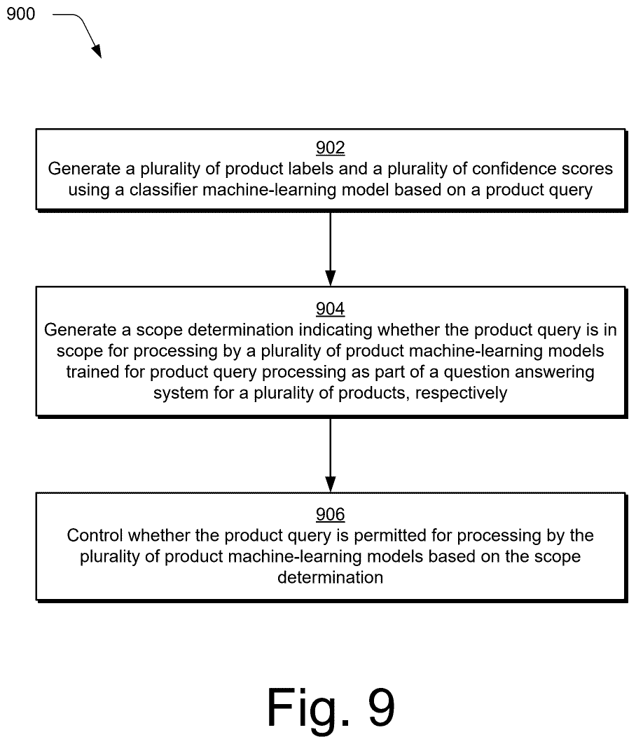

FIG. 9 is a flow diagram depicting an algorithm as a step-by-step procedure in an example implementation of operations performable for accomplishing a result of product query processing control based on a scope determination.

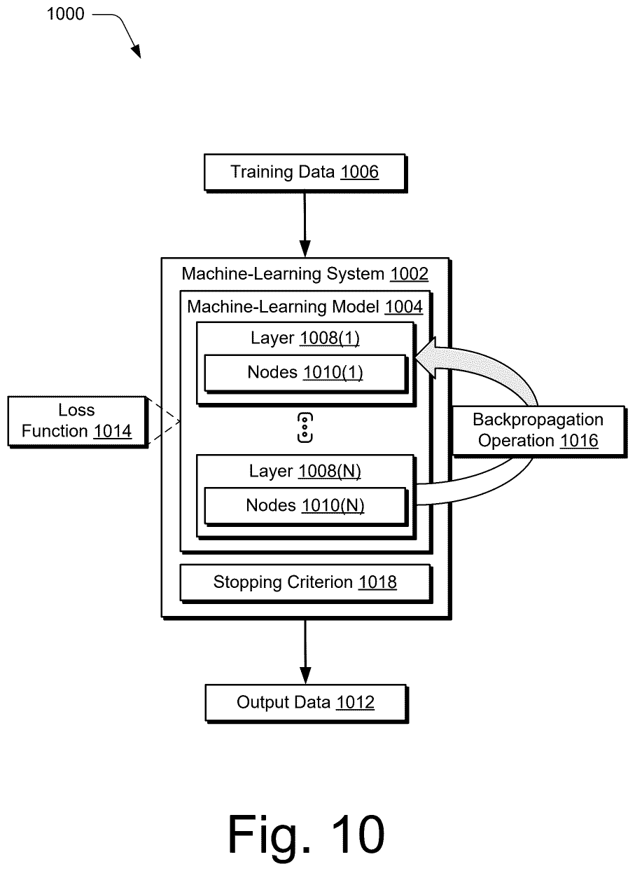

FIG. 10 depicts a system in an example implementation showing training of a machine-learning model of FIGS. 1-9 in greater detail.

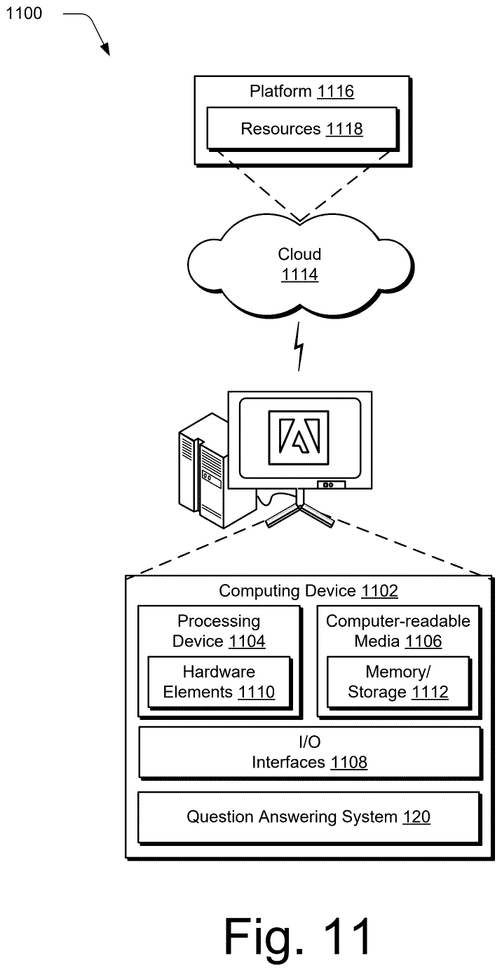

FIG. 11 illustrates an example system including various components of an example device that can be implemented as any type of computing device as described and/or utilize with reference to FIGS. 1-10 to implement embodiments of the techniques described herein.

### DETAILED DESCRIPTION

### Overview

Question answer systems, as conventionally implemented, are configured in real world situations to either support generalized usage or use in specific scenarios through use of training data that is curated for these particular scenarios. A query involving a “layer,” for instance, may vary greatly in different usage scenarios, e.g., layering articles of clothing, layers of a digital image, cake layers, and so forth. Therefore, usage of the machine-learning model in scenarios that are “out of scope” of training of the machine-learning model result in inaccuracies as well as inefficient use of computational and power resources.

To address these and other technical challenges, a relationship classifier and query scope control techniques are described. The techniques are configured to control use of machine-learning models to process a product query in order to generate a query result as part of a question answering system. The question answering system, for instance, employs the relationship classifier to determine whether a product query is “in scope” for use by a particular machine-learning model, group of machine-learning models, and so forth. In this way, the techniques described herein address technical challenges in improving accuracy of the query result as well as improve power and computational resource efficiency.

In one or more examples, a classifier is trained using training data that includes user-generated queries and machine-generated queries. The machine-generated queries, for instance, are generated through use of a prompt generation module that generates a set of prompts based on a product corpus associated with a particular product, e.g., for which a product machine-learning model is trained for questioning a question.

To do so in at least one example, the prompt generation module generates a series of prompts configured to cause the machine-learning model (e.g., an LLM) to generate a series of machine-generated queries over a plurality of iterations having, respectively, increased amounts of abstraction with respect to a previous iteration. A first prompt, for instance, is specific and used to generate a specific machine-generated query and one or more ground truth product labels corresponding to the product. The specific machine-generated query is then processed again by the machine-learning model with an under-specified prompt to increase a level of abstraction in the under-specified machine-generated query, e.g., to replace product names with abbreviations. This output may be further processed by the machine-learning model subject to a vague prompt that indicates that the machine-learning model is to omit product mentions. In this way, an amount of abstraction in the machine-generated queries increases over successive iterations in this example. This training data may be generated for a plurality of different products.

A sampling technique may also be employed by the question answering system to promote a training mixture having machine and user generated queries. The question answering system, for instance, may leverage a sampling technique as including positive and negative examples based on text from the product corpus such that the negative examples include hard negative text that is semantically close in an embedding space to the positive examples. Easier negative text are also included that is further away from the positive examples than the hard negative text in the embedding space. In this way, the samples included in the training data are balanced, thereby promoting training accuracy of the classifier machine-learning model.

The classifier machine-learning model is then trained based on the training data, e.g., using the user-generated queries and the synthesized machine-generated queries. Further discussion of training the classifier machine-learning model may be found in relation to FIGS. 3 and 10 as implementing a loss function over a plurality of iterations until convergence is achieved.

Once the classifier machine-learning model is trained, the classifier machine-learning model is configured to determine whether a product query is “in scope” or “out of scope” of processing supported by the plurality of product machine-learning models. To do so, for instance, the classifier machine-learning model generates a classifier output that includes a product label and confidence score (e.g., a probability) that the product label corresponds to the product query, e.g., for each of the products supported by the plurality of product machine-learning models.

The classifier output is then used by a scope determination module to determine whether the product query is “in scope,” e.g., by comparing the confidence scores with a threshold. The scope determination, for example, is configurable as a binary indication indicating whether the product query is accepted or rejected.

If rejected, a query result is output to an originator of the product query indicating the rejection and processing of the product query by the product machine-learning models is avoided (i.e., further processing is terminated) thereby conserving processing and power resources as well as protecting against inaccuracies. If accepted, on the other hand, the query result includes a product answer to the product query, e.g., formed from a corresponding one of the product machine-learning models, based on an output of the plurality of machine-learning models as a whole (e.g., weighted output as an ensemble mode), and so forth. In this way, the classifier machine-learning model operates as part of a relationship classifier system to control processing of a product query by product machine-learning models through query scope control. Further discussion of these and other examples is included in the following sections and shown in corresponding figures.

### TERM EXAMPLES

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Question Answering Environment

FIG. 1 is an illustration of a digital medium environment 100 in an example implementation that is operable to employ relationship classifier and query scope control techniques through use of a classifier machine-learning model as described herein. The illustrated environment 100 includes a service provider system 102 and a computing device 104 that are communicatively coupled, one to another, via a network 106. Computing devices are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 11.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are employed to receive a product query 116 and produce a query result 118 through use of a question answering system 120. Although the following discussion defines a scope as pertaining to particular products, the scope and corresponding training of machine-learning models configured to answer a question posed by the query include a variety of other usage scenarios, examples of which include different subjects, technical areas, languages (e.g., human, computer), genres, and so forth.

As previously described, accuracy of query processing by a machine-learning model is directly dependent on what training data is used to train the machine-learning model. Therefore, processing that is “out of scope” of this training by a respective machine-learning model results in inaccuracies and inefficient use of computational resources.

Accordingly, to address this and other technical challenges, the question answering system 120 employs a relationship classifier system 122 that is configurable to generate a scope determination 124. The scope determination 124 indicates whether the product query 116 is “in scope” or “out of scope” for processing by an answer generation system 126, and more particularly for one or more product machine-learning models 128.

Individual product machine-learning models 128, for instance, are trained using training data generated from a product corpus that is associated with a respective product. Therefore, the product machine-learning model 128 is configured with a degree of specificity in this example suitable to answer a detailed product query 116 relating to that product. The plurality of product machine-learning models 128, for instance, are designed to support a predefined set of products in this example, respectively. In this way, training of each underlying product machine-learning models 128 for a particular scope supports improved performance in operation in relation to that scope. However, accuracy of that operation may suffer when tasked with product queries outside of that scope.

To address these technical challenges, the relationship classifier system 122 is configured to determine whether the product query 116 is “in scope” of processing of one or more of the product machine-learning model 128 of the answer generation system 126. As a result, the relationship classifier system 122 improves operational accuracy and performance of the question answering system 120 in generating the query result in response to the product query 116. Although operation of the question answering system 120 is illustrated as implemented by the digital services 112, local operation is also contemplated, e.g., locally by the computing device 104.

FIG. 2 depicts a system 200 in an example implementation showing operation of the relationship classifier system 122 of the question answering system 120 of FIG. 1 in greater detail. The relationship classifier system 122 as previously described is configured to output a scop determination 124 to determine whether a product query 116 is “in scope” for further processing by the answer generation system 126. To do so, a classifier machine-learning model 202 is trained using training data to generate a classifier output 204. In one or ore examples, the classifier machine-learning model 202 is configured as a multi-label classifier that is configured to output a product label 206 and a confidence score 208 (e.g., probability) that the product query 116 corresponds to that product label 206.

A scope determination module 210 then takes the classifier output 204 as an input along with a product list 212 in this example to generate the scope determination 124 indicating whether the product query 116 is within scope of the answer generation system 126. And more particularly, first through “N” product machine-learning models 128(1)-128(N) trained for respective products. The scope determination module 210, for instance, employs a threshold (e.g., individually for each product type or a generalized threshold) that is usable as a basis to determine a binary condition of “in scope” or “out of scope.”

In an implementation, if the scope determination 124 indicates “out of scope,” then the product query 116 is not forwarded to the answer generation system 126 for processing but rather further processing ceases. An indication is instead communicated to an originator of the product query 116, e.g., the computing device 104. If the scope determination 124 indicates “in scope,” processing of the product query 116 by the answer generation system 126 is permitted. The product query 116, for instance, may be routed to those of the first through “N” product machine-learning models 128(1)-128(N) that meet the threshold, permitted for processing by each of the first through “N” product machine-learning models 128(1)-128(N) regardless of whether a corresponding model meets the confidence score 208, and so forth. Further discussion of generation of training data, use of the training data to train the classifier machine-learning model 202, and use of the trained classifier machine-learning model 202 is described in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Relationship Classifying Techniques for Query Scope Control

The following discussion describes example relationship classifying techniques for query scope control that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 3 depicts a system 300 in an example implementation showing operation of the relationship classifier system 122 of FIG. 1 in greater detail as collecting user-generated queries and generating machine-generated queries in order to train the classifier machine-learning model 202 of FIG. 2. A user training data collection module 302 is employed in the illustrated example to collect a user-generated query 304 from a data source 306, e.g., production logs of the question answering system 120 of past product queries 116. The user-generated query 304, for instance, may be collected for a particular product (e.g., as input via a user interface of the user training data collection module 302), collected over a defined amount of time, and so forth. As a result, the user-generated queries 304 provide a detailed and realistic representation of user behavior, although in practice have limited scale and high data sparsity.

To address this technical challenge, the relationship classifier system 122 is also configurable to employ a machine training data generation module 308 that is configured to synthesize a machine-generate query 310. To do so, a prompt generation module 312 is configured to generate a prompt for processing by a machine-learning model 314 (e.g., a language model such as a large language model LLM) to generate the machine-generated query 310.

The prompt generation module 312, for instance, selects a portion of a product corpus 316 illustrated as maintained in a storage device 318 as part of the prompt for processing by the machine-learning model 314. In this way, the machine-generate query 310 is ensured as being relevant to a particular product, for which, a corresponding product machine-learning model 128 is trained, e.g., which may be implemented using the same or different training data used to train a respective product machine-learning model 128. Sampling techniques may also be employed by a sampling module 320 to promote balancing of types of machine-generate queries 310 used for training the classifier machine-learning model 202 by a machine learning training module 322.

The classifier machine-learning model 202, for instance, may be defined as a language model (LM) trained on examples of questions and respective product labels. The classifier machine-learning model 202, for instance, may be configured solely as an encoder language model. The classifier machine-learning model 202, once trained, is configured to receive as an input the product query 116 and output a scope determination 124, which may include product label 206 and confidence score 208 as described in relation to FIG. 2. Therefore:

$$SentenceTransformer ( X ) \to y$$

$$ProductClassifier ( q ) \to \{ s 1 , s 2 , … , sN \}$$

$$with 0. \leq s \leq 1. for each {i}^{t h} product label$$

The detection task of the classifier machine-learning model 202 is therefore definable over the following operation over the classifier machine-learning model 202, given the outputs of “ProductClassifer(q)” from above and a threshold 0:

$${s}_{i}^{′} ∀ i ∈ InScopeProduccts where {s}_{i}^{′} = \{ \begin{matrix}False , {s}_{i} < θ \\ True , \\ {s}_{i} \geq θ\end{matrix}$$

$$∴ IsInScope ( q ) = {⋁}_{i = 1}^{14} {s}_{i}^{′}$$

As a binary classification, each class of out-of-scope detection may be evaluated in terms of precision and recall, with “TP” denoting “true positives” and “FP” denoting false positives,” and “FN” denoting “false negatives” as follows:

$$Precision = \frac{TP}{TP + FP} and Recall = \frac{TP}{TP + FN}$$

“Precision” of a class denotes the correctness of “IsInScope(q)” with respect to that class, whereas “recall” of a class denotes completeness of “IsInScope(q)” with respect to that class. Accordingly, different values of “q” yield different precision/recall results. The “recall” of real “in-scope” queries captures a proportion of valid questions that are wrongly rejected, whereas the recall of real “out-of-scope” queries captures a proportion of invalid questions that that are wrongly processed in an attempt to answer, risking production of unreliable answers that can erode user trust. In practice, however, a modelling challenges has been identified in training the classifier machine-learning model 202 to comprehensively cover a product query 116 about products that are “in scope” using both user-generated query 304 that are sparse with machine-generate query 310 which are complete but may exhibit a bias towards unsupported products. Accordingly, the relationship classifier system 122 is configured to address these and other technical challenges through use of an iterative abstraction technique as well as a sampling technique to promote sample balancing, examples of which are further described in the following discussion and shown in corresponding figures.

FIG. 4 depicts a system 400 in an example implementation of incremental prompt generation over successive iterations as promoting increasing levels of abstraction in machine-generated queries by a prompt generation module 312. FIG. 5 is a flow diagram depicting an algorithm 500 as a step-by-step procedure in an example implementation of operations performable for accomplishing a result of generating a series of prompts over a series of iterations having, successively, increased levels of abstraction with respect to a previous iteration. FIG. 6 is a flow diagram depicting an algorithm 600 as a step-by-step procedure in an example implementation of operations performable for accomplishing a result of generating a series of three prompts with causes the machine-learning model 314 to generate a corresponding series of three machine-generated queries 310. In the following discussion reference is made in parallel to FIGS. 4-6.

As previously described in relation to FIG. 3, the user training data collection module 302 is configurable to collect user generated queries 304 associated with a plurality of products (block 502) that describe real-world user interaction with the question answering system 120. In the example of FIG. 4, the machine training data generation module 308 is implemented to generate a series of prompts configured to cause at least one machine-learning model to generate a series of machine-generated queries over a plurality of iterations having, respectively, increased amounts of abstraction with respect to a previous said iteration (block 504). A classifier machine-learning model 202 is then trained to control whether processing of a product query is permitted by a plurality of product machine-learning models associated, respectively, with the plurality of products. The training is based on the user-generated queries and the series of machine-generated queries (block 506).

In this example, selecting a sample that represents positive, in-scope paragraphs and negative, out-of-scope paragraphs is the first part for synthesizing machine-generated queries that comprehensively cover a space of possible product queries, when compared to user-generated questions. FIG. 4 shows an example implementation of the steps employed by the prompt generation module 312 based on the product corpus 316 to generate a series of three prompts with causes the machine-learning model 314 to generate a corresponding series of three machine-generated queries 310.

In the illustrated example, a prompt generation module 312 begins by selecting a portion of text from a product corpus 316 (e.g., a paragraph) and forms a first prompt as a specific prompt 402(1) for processing by the machine-learning model 314 (block 602). In this example at the first iteration, the specific prompt 402(1) is configured to cause the machine-learning model 314 to generate a specific machine-generation query 310(1) based on the portion of text.

The specific prompt 402(1), for instance, specifies “generate a question from the text below, mentioning products from this list if the text described the product, text:” which is followed by the portion of text taken from the product corpus 316. In response, the machine-learning model 314 generates a specific machine-generated query 310(1) (block 604) of “what is streaming segmentation in Product Experience Platform” as well as ground truth product labels 404 of products associated with that portion of text.

Next, the prompt generation module 312 generates a second prompt (e.g., under-specified prompt 402(2)) based on the first machine-generated query. The second prompt is configured to cause the machine-learning model 314 to generate a second machine-generated query as an abstraction of the first machine-generated query (block 606). The under-specified prompt 402(2), for instance, specifies “Extract each of the product names from the list and replace with corresponding acronyms” and includes the text of the first machine-generated query. In response to processing the second prompt (e.g., the under-specified prompt 402(2)) based on the under-specified prompt 402(2), the machine learning model 314 receives a second machine-generated query as an abstraction of the first machine-generated query. An under-specified machine-generate query 310(2), for instance, includes text of “What is streaming segmentation in PEP” by including an abbreviation for the Product Experience Platform.

This process may then continue over a third iteration. In this iteration the prompt generation module 312 generates a third prompt (e.g., vague prompt 402(3)) based on the second machine-generated query (block 608). The third prompt is configured to cause the machine-learning model 314 to generate a third machine-generated query as an abstraction of the second machine-generated query, an example of which is illustrated as vague machine-generated query 310(3). Text of the vague machine-generated query 310(3) in this example includes “what is streaming segmentation.”

The training data, once generated, is then usable to train the classifier machine-learning model 202 to control whether processing of a product query 116 is permitted by a product machine-learning model 128 associated with the product (block 610). In an example, the classifier machine-learning model 202 is trained to control whether processing of a product query is permitted by a plurality of product machine-learning models associated, respectively, with the plurality of products, the training based on the user-generated queries and the series of machine-generated queries (block 506). Training data, for instance, is generated such that each of the machine-generated queries are associated with the ground truth product labels 404 generated in the first iteration. In this way, the classifier machine-learning model 202 is trained to support different levels of abstraction in the product query 116, thereby improving accuracy and efficiency of computation and power resources by the question answering system 120.

FIG. 7 depicts an example implementation 700 of sample selection for inclusion in training data to train the classifier machine-learning model 202 of FIG. 2. This example implementation 700 depicts a first instance 702, a second instance 704, and a third instance 706 of an embedding space 708. At the first instance 702, in-scope 710 samples are selected from the product corpus 316 (e.g., via uniform resource locators) that cover in-scope products in order to generate positive examples.

At the second instance 704, hard negative 712 samples are selected that are semantically similar to the in-scope 710 samples, and as such have increased difficultly in supporting differentiation from the in-scope 710 samples. Further, with the negative samples as shown at the third instance 706, relative easy negative 714 samples are selected based on the embedding space 708 when populating the training data. In this way, samples in the training data are balanced with respect to hard and easy to discriminate examples, which is then used to train the classifier machine-learning model 202.

In an implementation, let “φ” denote an embedding function that encodes a portion of that an embedding space 708 learned by a machine-learning model, e.g., a sentence transformer. Also, let “r” denote a reference portion of text (e.g., a paragraph) and “D” a full set of paragraphs from the product corpus 316. A retriever of the “n” paragraphs from the product corpus 316 that are most similar to “r” is definable as:

$$Retriever ( r , D , n ) = {arg max}_{p} cos [ ϕ ( q ) , ϕ ( p ) ] ∀ p ∈ D$$

which is computed “n” times to remove previously retrieved “p′s” from “D” such that:

$$Retriever ( r , D , n ) \to {P}_{n}$$

where “Pₙ” represents the “n” distinct top matches from “D” with respect to “r” in ascending order.

The indexed portions of the product corpus 316 are considered positive samples in this example and an equal number of negative samples are retrieved from the remaining portions of the product corpus 316, e.g., that are not indexed. Half of these are sampled as harder negatives and half as easier negatives. The harder negatives are then sampled such that a first subset of the positive samples is randomly selected and for each reference paragraph “r,” “P₁” is retrieved from a negative set and the first “p” is taken as a negative sample. After removing previously selected samples, a second subset of the positive samples is randomly selected and for each reference paragraph “r” in this selection, “Pₙ” is retrieved from the negative set and the “n^{th} p” is taken as a negative sample.

This process is repeated for additional subsets of the positive samples, each time increasing a value of “n” for the retrieved “Pₙ” and taking the “nth p” as a negative sample. The process continues until a desired number of harder negative samples is obtained. Lastly, the easier negatives are randomly sampled from the remaining paragraphs in the negative set after removing each of previously selected samples. In this way, a final sample is formed that fully covers the product and is balanced between positive and negative samples. Within the negative samples, a balance is also achieved between hard and easy to discriminate examples.

Returning again to FIG. 3, the machine learning training module 322 then employs this training data to train the classifier machine-learning model 202. The training data mixture is formed by combining both machine- and user-generated question sets, as follows. The specific machine-generated queries 310(1) are shuffled and split between training and validation sets, e.g., a majority for training and a minority for testing. Once a specific machine-generated query 310(1) is assigned to a split, each of its abstractions are assigned to the same split to prevent contamination of the validation set with signal from the training set.

The training data from the user-generated query 304 is appended to an end of the training set from the machine-generate query 310, creating a curriculum that begins with synthetic queries and concludes with realistic, user-generated queries 304. The validation sets are also appended, in this case without a particular order.

The classifier machine-learning model 202 is trainable on the training data (i.e., pairs of question and product labels), with the following hyperparameters:
a learning rate in the order of 3×10⁻⁵;
a weight decay value;
a batch size;
a set number of epochs; and
validation metric set to an F1-score.
   Similar to other machine learning techniques, a best machine-learning model may be determined by a validation metric, which in this case typically occurs after a certain number of epochs.

FIG. 8 depicts a system 800 in an example implementation of use of the classifier machine-learning model 202 as trained using the training data of FIGS. 5-7 is used to implement query scope control. FIG. 9 is a flow diagram depicting an algorithm 900 as a step-by-step procedure in an example implementation of operations performable for accomplishing a result of product query processing control based on a scope determination.

This example begins with input of a product query 116 into the question answering system 120. This product query 116 is then processed by the relationship classifier system 122, which contains a classifier machine-learning model 202. In a first step (block 902), the classifier model 202 generates a classifier output 204 that includes a plurality of product labels 206(1)-206(N) and corresponding confidence scores 208(1)-208(N) based on the product query 116. This output provides an assessment by the classifier machine-learning model 202 of how closely the query relates to various products supported by the answer generation system 126.

Next, the question answering system 120 proceeds to generate a scope determination 124 (block 904). The classifier output 204, for instance, is processed by the scope determination module 210 to evaluate whether the product query 116 is within the scope of processing capabilities of the product machine-learning models 128(1)-128(N) in the answer generation system 126. The scope determination 124 generates a binary indicator 802 that indicates whether the product query 116 is accepted or rejected. The binary indication 802 is then used to control whether the product query is permitted for processing by the plurality of product machine-learning models based on the scope determination (block 906).

In the first scenario, if the scope determination 124 results in a binary indication 802 of “rejected,” a rejection is formed such that the query result 118(1) includes a rejection indication. This rejection result is then sent to the computing device 104, indicating that the product query 116 is outside the scope of the capabilities of the answer generation system 126. As a result, processing of the product query 116 by the first through “N” product machine-learning models 128(1)-128(N) is prevented based on the scope determination 124.

In the second scenario, if the scope determination 124 includes a binary indication 802 of “accepted,” the scope determination module 210 passes the product query 116 to the answer generation system 126 continues to the answer generation system 126. Thus, in this case, the processing of the product query 116 is permitted as being “in scope.” The product query 116 is passed to the answer generation system 126 for processing by one or more of the first through “n” product machine-learning models 128(1)-128(N). These first through “n” product machine-learning models 128(1)-128(N) analyze the product query 116 and generate a query result 118(2), which is then sent to the computing device 104 as an answer to the question posed by the product query 116.

In this way, the relationship classifier and query scope control techniques described in the document offer several technical advantages for the question answering system 120. By employing a classifier machine-learning model 202 trained on both user-generated and machine-generated queries, the question answering system 120 is configured to accurately determine whether a product query is within the scope of processing capabilities of corresponding product machine-learning models. This approach improves accuracy in query processing while also enhancing computational efficiency and power conservation by avoiding unnecessary processing of out-of-scope queries. The question answering system 120 also supports an ability to generate machine-generated queries with increasing levels of abstraction that further supports comprehensive training data, addressing challenges related to data sparsity and bias when limited to sole use of user-generated queries. Additionally, the sampling technique used in training data generation promotes a balanced dataset, further improving performance of the classifier machine-learning model 202. As a result, the relationship classifier and query scope control techniques enable a question answering system 120 to strike a balance between generalized usage and applicability to specific scenarios, resulting in increased accuracy and efficient query processing across a variety of usage scenarios.

FIG. 10 depicts a system in an example implementation 1000 showing training of a machine-learning model of FIGS. 1 and 6 in greater detail. The machine-learning system 1002 implementation a machine-learning model 1004 as an example of the answer generation system 126. The machine-learning system 1002 is representative of functionality to generate training data 1006 (e.g., includes the user-generated query 304 and the machine-generate query 310), use the generated training data 1006 to train the machine-learning model 1004, and/or use the machine-learning model 1004 as implementing the functionality described herein.

A machine-learning model 1004 refers to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In the illustrated example, the machine-learning model 1004 is configured using a plurality of layers 1008(1), . . . , 1008(N) having, respectively, a plurality of nodes 1010(1), . . . , 1010(N). The plurality of layers 1008(1)-1011(N) are configurable to include an input layer, an output layer, and one or more hidden layers. Calculations are performed by the nodes 1010(1)-1010(N) within the layers via hidden states through a system of weighted connections that are “learned” during training of the machine-learning model 1004 to implement a variety of tasks.

In order to train the machine-learning model 1004, training data 1006 is received that provides examples of “what is to be learned” by the machine-learning model 1004, i.e., as a basis to learn patterns from the data. The machine-learning system 1002, for instance, collects and preprocesses the training data 1006 that includes input features and corresponding target labels, i.e., of what is exhibited by the input features. The machine-learning system 1002 then initializes parameters of the machine-learning model 1004, which are used by the machine-learning model 1004 as internal variables to represent and process information during training and represent interferences gained through training. In an implementation, the training data 1006 is separated into batches to improve processing and optimization efficiency of the parameters of the machine-learning model 1004 during training.

The training data 1006 is then received as an input by the machine-learning model 1004 and used as a basis for generating predictions based on a current state of parameters of layers 1008(1)-1008(N) and corresponding nodes 1010(1)-1010(N) of the model, a result of which is output as output data 1012. Output data 1012 describes an outcome of the task, e.g., as a probability of being a member of a particular class in a classification scenario.

Training of the machine-learning model 1004 includes calculating a loss function 1014 to quantify a loss associated with operations performed by nodes of the machine-learning model 1004. The calculating of the loss function 1014, for instance, includes comparing a difference between predictions specified in the output data 1012 with target labels specified by the training data 1006. The loss function 1014 is configurable in a variety of ways, examples of which include regret, Quadratic loss function as part of a least squares technique, and so forth.

Calculation of the loss function 1014 also includes use a backpropagation operation 1016 as part of minimizing the loss function 1014 and thereby training parameters of the machine-learning model 1004. Minimizing the loss function 1014, for instance, includes adjusting weights of the nodes 1010(1)-1010(N) in order to minimize the loss and thereby optimize performance of the machine-learning model 1004 in performance of a particular task. The adjustment is determined by computing a gradient of the loss function 1014, which indicates a direction to be used in order to adjust the parameters to minimize the loss. The parameters of the machine-learning model 1004 are then updated based on the computed gradient.

This process continues over a plurality of iteration in an example until a stopping criterion 1018 is met. The stopping criterion 1018 is employed by the machine-learning system 1002 in this example to reduce overfitting of the machine-learning model 1004, reduce computational resource consumption, and promote an ability of the machine-learning model 1004 to address previously unseen data, i.e., that is not included specifically as an example in the training data 1006. Examples of a stopping criterion 1018 include but are not limited to a predefined number of epochs, validation loss stabilization, achievement of a performance improvement threshold, or based on performance metrics such as precision and recall.

### Example System and Device

FIG. 11 illustrates an example system generally at 1100 that includes an example computing device 1102 that is representative of one or more computing systems and/or devices that implement the various techniques described herein. This is illustrated through inclusion of the question answering system 120. The computing device 1102 is configurable, for example, as a server of a service provider, a device associated with a client (e.g., a client device), an on-chip system, and/or any other suitable computing device or computing system.

The example computing device 1102 as illustrated includes a processing device 1104, one or more computer-readable media 1106, and one or more I/O interface 1108 that are communicatively coupled, one to another. Although not shown, the computing device 1102 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1104 is representative of functionality to perform one or more operations using hardware. Accordingly, the processing device 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112 that stores instructions that are executable to cause the processing device 1104 to perform operations. The computer-readable storage medium is configured for storing instructions that, responsive to execution by the processing device, causes the processing device to perform operations. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing device 1104. The instructions and/or functions are executable/operable by one or more articles of manufacture (for example, one or more computing devices 1102 and/or processing devices 1104) to implement techniques, modules, and examples described herein.

The techniques described herein are supported by various configurations of the computing device 1102 and are not limited to the specific examples of the techniques described herein. This functionality is also implementable all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

In implementations, the platform 1116 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
generating, by a processing device, a first prompt configured to cause at least one machine-learning model to generate a first machine-generated query based on a product corpus associated with a product;
receiving, by the processing device, the first machine-generated query and one or more ground truth product labels corresponding to the product from the at least one machine-learning model;
generating, by the processing device, a second prompt based on the first machine-generated query, the second prompt configured to cause the at least one machine-learning model to generate a second machine-generated query as an abstraction of the first machine-generated query; and
training, by the processing device, a classifier machine-learning model to control whether processing of a product query is permitted by a product machine-learning model associated with the product, the training based on training data including the first and second machine-generated queries and the one or more ground truth product labels.

2. The method as described in claim 1, wherein the training data further includes at least one user-generated query and the training data is ordered such that training begins with at least one of the first and second machine-generated queries and then continues with the at least one user-generated query.

3. The method as described in claim 1, wherein the training is performed such that the one or more ground truth product labels are associated with both the first prompt and the second prompt.

4. The method as described in claim 1, wherein the classifier machine-learning model, once trained, is configured to output a plurality of product labels corresponding to a plurality of said products and a plurality of confidence scores, respectively.

5. The method as described in claim 4, wherein the control is configured to cause the processing of the product query to be rejected responsive to determining that each confidence score of the plurality of confidence does not meet a defined threshold.

6. The method as described in claim 1, further comprising generating the training data using a sampling technique as including positive and negative examples based on text from the product corpus such that the negative examples include hard negative text that is semantically close in an embedding space to the positive examples and easier negative text that is further away from the positive examples than the hard negative text in the embedding space.

7. The method as described in claim 1, further comprising generating a scope determination based on the product query based at least in part on the classifier machine-learning model once trained.

8. The method as described in claim 7, wherein the scope determination is configured as a binary indication indicating the processing of the product query is permitted or the processing of the product query is not permitted.

9. The method as described in claim 1, further comprising generating, by the processing device, a third prompt based on the second machine-generated query, the third prompt configured to cause the at least one machine-learning model to generate a third machine-generated query as an abstraction of the second machine-generated query.

10. The method as described in claim 9, wherein the second prompt is configured to replace a name of the product in the first machine-learning query with an acronym and the third prompt is configured to omit mentions of the product.

11. The method as described in claim 1, wherein the at least one machine-learning model is configured as a large language model (LLM) and the product machine-learning model is trained, at least in part, on the product corpus.

12. A computing device comprising:
a processing device; and
a computer-readable storage medium storing instructions that, responsive to execution by the processing device, causes the processing device to perform operations including:
generating a plurality of product labels and a plurality of confidence scores using a classifier machine-learning model based on a product query;
generating a scope determination indicating whether the product query is in scope for processing by a plurality of product machine-learning models trained for product query processing as part of a question answering system for a plurality of products, respectively; and
controlling whether the product query is permitted for processing by the plurality of product machine-learning models based on the scope determination.

13. The computing device as described in claim 12, wherein the scope determination is configurable as a binary indication.

14. The computing device as described in claim 13, wherein the binary indication is configured to indicate whether processing of the product query is or is not permitted for the plurality of product machine-learning models as a whole.

15. The computing device as described in claim 12, wherein the operations further include communicating a query result indicating that processing of the product query is outside a scope of the plurality of product machine-learning models.

16. One or more computer-readable storage media storing instructions that, responsive to execution by a processing device, causes the processing device to perform operations comprising:
collecting user generated queries associated with a plurality of products;
generating a series of prompts configured to cause at least one machine-learning model to generate a series of machine-generated queries over a plurality of iterations having, respectively, increased amounts of abstraction with respect to a previous said iteration;
training a classifier machine-learning model to control whether processing of a product query is permitted by a plurality of product machine-learning models associated, respectively, with the plurality of products, the training based on the user generated queries and the series of machine-generated queries.

17. The one or more computer-readable storage media as described in claim 16, wherein the classifier machine-learning model, once trained, is configured to output a plurality of product labels corresponding to a plurality of said products and a plurality of confidence scores, respectively.

18. The one or more computer-readable storage media as described in claim 16, wherein a first said iteration causes the at least one machine-learning model to generate one or more ground truth product labels.

19. The one or more computer-readable storage media as described in claim 18, wherein the training is performed for the series of machine-learning queries as each associated, respectively, with the one or more ground truth product labels for a respective said product.

20. The one or more computer-readable storage media as described in claim 16, wherein the operations further include communicating a query result indicating that processing of the product query is outside a scope of the plurality of product machine-learning models.
